(19) United States
(12) Patent Application Publication
(10) Pub. No.: US 2022/0234311 A1
(43) Pub. Date: Jul. 28, 2022

(54) A FIBRE PLACEMENT HEAD

(71) Applicant: ROLLS-ROYCE PLC, London (GB)

(72) Inventor: Gonçal Berastegui, London (GB)

(21) Appl. No.: 17/615,143

(22) PCT Filed: Apr. 30, 2020
(86) PCT No.: PCT/EP2020/062101

§ 371 Date: Nov. 30, 2021

(30) Foreign Application Priority Data
May 30, 2019 (GB) 1907654.6

(51) Int. Cl. B29C 70/38; B29C 70/56; B29C 70/16

(52) U.S. Cl. CPC B29C 70/384; B29C 70/16; B29C 70/56

(57) ABSTRACT

A fibre placement head includes a roller mount having an axle defining a roller axis, and a hollow roller defining an internal chamber. The roller is mounted on the axle and configured to rotate about the roller axis. The fibre placement head also comprises a pressurised fluid system configured to deliver and discharge pressurised fluid to and from the internal chamber of the roller, to vary a stiffness of the roller by varying a pressure of fluid in the chamber. The fibre placement head may also be included in a fibre placement machine having the fibre placement head, and a method of laying up fibre reinforcement material using the fibre placement head.

### CROSS-REFERENCE TO RELATED APPLICATIONS

This application is a U.S. National Stage Application under 35 U.S.C. § 371 of International Application No. PCT/EP2020/062101, filed Apr. 30, 2020, which claims the benefit of priority to United Kingdom Application No. GB 1907654.6, filed May 30, 2019, and the present application claims priority to and the benefit of the filing date of both of these prior applications, which are incorporated by reference herein in their entireties.

### TECHNICAL FIELD

The present invention relates to a fibre placement head, a fibre placement machine having the fibre placement head, and a method of laying up fibre reinforcement material with the fibre placement head.

### BACKGROUND

Fibre placement machines are used to place fibres or tows of fibre reinforcement material on a lay-up surface to form a pre-form of fibre reinforcement material. Fibre placement machines typically comprise a fibre placement head having a roller for compacting and steering fibres during a lay-up operation.

### BRIEF SUMMARY

According to a first aspect, there is provided a fibre placement head comprising: a roller mount comprising an axle defining a roller axis; a hollow roller defining an internal chamber, the roller being mounted on the axle and configured to rotate about the roller axis; and a pressurised fluid system configured to deliver and discharge pressurised fluid to and from the internal chamber of the roller, to vary a stiffness of the roller by varying a pressure of fluid in the chamber.

The pressurised fluid system may be configured to deliver and discharge pressurised fluid to and from the internal chamber of the roller through the axle of the roller mount.

The pressurised fluid system may comprise a controller configured to control the discharge and optionally the delivery of the fluid in the chamber to control the pressure in the chamber.

The pressurised fluid system may comprise a pressurised fluid inlet configured to be fluidically connected to a pressurised fluid source. The pressurised fluid system may comprise a pressurised fluid outlet configured to allow discharge of fluid from the chamber.

The pressurised fluid system may comprise an outlet valve disposed at the pressurised fluid outlet. The outlet valve may be selectively openable to allow discharge of the fluid from the chamber, to thereby control the pressure within the chamber.

The pressurised fluid system may comprise an outlet valve disposed at the pressurised fluid outlet. The outlet valve may have a pressure release threshold such that the outlet valve passively opens when pressure of fluid in the chamber exceeds the pressure release threshold. The controller may be configured to control the pressure release threshold of the outlet valve.

The term “passively” is intended to mean that the outlet valve opens under mechanical load caused by the pressure of the fluid, rather than by a controllable actuator or the like.

The pressurised fluid system may comprise an inlet valve disposed at the pressurised fluid inlet. The controller may be configured to control selective opening and closing of the inlet valve. Selectively controlling the opening and closing of the inlet valve may be independent of any control of the pressure release threshold.

The controller may be configured to receive pressure control data, relating to time-varying or space-varying optimised pressure within the chamber along a pre-programmed headpath for the fibre placement head. The controller may be configured to control the pressure in the chamber based on the pressure control data such that the stiffness of the roller is varied along the head path of the fibre placement head.

The stiffness of the roller may be varied to optimise the stiffness. Optimising the stiffness of the roller may comprise determining an optimal compromise in stiffness of the roller between steering performance and roller crush performance.

The fluid may be a gas such as air. The pressurised fluid system may comprise a pressurised fluid source connected to the pressurised fluid inlet. The pressurised fluid source may be a pneumatic actuator.

The pressurised fluid system may comprise a sensor disposed within the chamber to monitor the pressure of the fluid within the chamber and to generate a pressure parameter which is representative of the pressure in the chamber.

The controller may receive the pressure parameter from the sensor, and may control discharge of the pressurised fluid from the chamber based on the pressure parameter.

The pressurised fluid system may be configured to deliver heated pressurised fluid to the internal chamber of the roller.

According to a second aspect, there is provided a fibre placement machine comprising a fibre placement head according to the first aspect.

According to a third aspect, there is provided a method of laying up fibre reinforcement material on a lay-up surface with a fibre placement head in accordance with the first aspect, the method comprising: controlling the discharge of fluid from the chamber of the roller to vary the pressure in the chamber of the roller during lay-up.

The method may further comprise controlling the delivery of fluid into the chamber of the roller to vary the pressure in the chamber of the roller during lay-up.

A controller may receive pressure control data relating to a predetermined variable stiffness, and wherein the controller controls the delivery of fluid from the chamber during lay-up based on the pressure control data. A controller may receive pressure control data relating to a predetermined variable stiffness, and wherein the controller controls the discharge of fluid from the chamber during lay-up based on the pressure control data.

The method may comprise determining pressure control data for controlling the discharge of fluid from the chamber of the roller during lay-up, wherein the determination is based on determining a variable stiffness of the roller along the headpath based on a profile of the lay-up surface along the headpath.

The profile of the lay-up surface may include at least a 2D profile of the lay-up surface at each of a plurality of lay-up locations along the headpath where the roller engages the lay-up surface. This may permit either a simulation of roller equipment or a rules-based determination of suitable roller stiffness or pressure for the profile.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a schematic perspective view of a first example fibre placement machine applying fibre reinforcement material on a tool;

FIG. 2 is a schematic cross-sectional view of a roller on a first example fibre placement head applying fibre reinforcement material on a substrate received on a tool;

FIG. 3 is a schematic cross-sectional view of a second example fibre placement head; and

FIG. 4 is a flow chart showing steps of a process for laying up tows using the first or second example fibre placement head.

### DETAILED DESCRIPTION

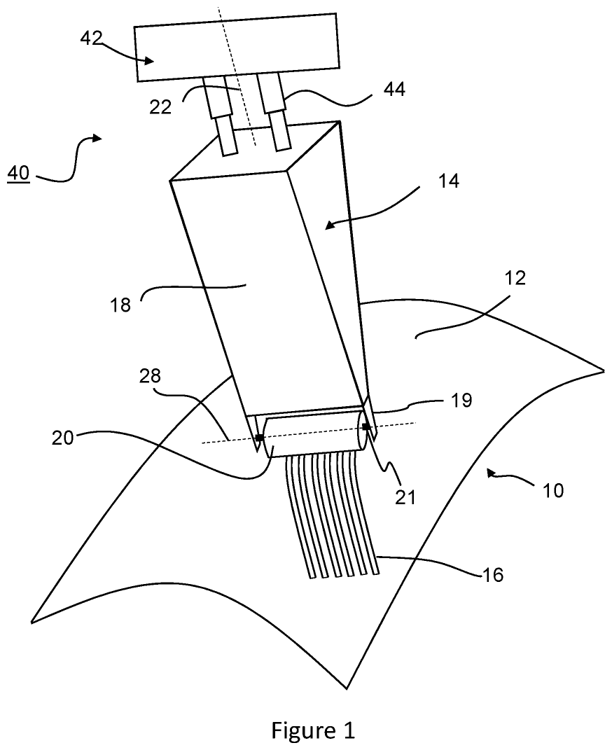

FIG. 1 shows a tool 10 defining a lay-up surface 12, and a fibre placement machine 40 disposed over the tool 10. The fibre placement machine 40 comprises a fibre placement head 14 disposed over and moveable relative the tool 10 to apply a plurality of tows 16 of fibre reinforcement material onto the lay-up surface 12. The fibre placement head 14 comprises a head body 18 extending along a generally longitudinal direction and supporting a roller 20 on a roller mount 19 at its distal end configured to traverse the lay-up surface 12 along a pre-programmed headpath to apply fibre reinforcement material thereto during a lay-up operation.

The fibre placement head 14 and tool 10 are moveable relative one another in six degrees of freedom including three degrees of translation and three degrees of rotation. In this particular example, the tool 10 is configured to remain static and the fibre placement head 14 is mounted to a support (not shown) configured to manipulate the fibre placement head 14 with up to six degrees of freedom. In other examples, the degrees of freedom may be distributed between the tool and the head, such that the tool and fibre placement head may both be configured to move (with respect to different degrees of freedom). For example, the tool may be configured to rotate about two rotational axis of freedom (e.g. pitch and roll) and one translational degree of freedom (e.g. a vertical or “z” direction, whereas the fibre placement head 14 may be mounted to a support (not shown) and configured to move with respect to the remaining rotational degree of freedom (e.g. “yaw”) and translational degrees of freedom (the lateral or “x” and “y” directions). In further examples, the fibre placement head may remain static and the tool may be configured to move relative the fibre placement head, but in other examples the degrees of freedom may be distributed between the tool and head in any combination.

As shown in FIG. 1, in this example the head body 18 extends along a generally longitudinal axis from a proximal end farthest from the tool to a distal end where the roller 20 is located for pressing against the tool 10.

The fibre placement head 14 is mounted to a support by a resilient mount 42 so that it is translatable with respect to the resilient mount along a compaction axis 22 in response to engaging the tool 10 or a substrate received on the tool 10. The resilient mount 42 is provided with a biasing mechanism 44 to urge the fibre placement head 14 along the compaction axis 22 relative the resilient mount towards the tool 10. In this particular example, the biasing mechanism 44 of the fibre placement machine 40 comprises compressed gas apparatus including a reservoir of compressed gas, a pressure-maintaining valve, and a pneumatic actuator (not shown) for driving the fibre placement head 14 along the compaction axis 22. The reservoir of compressed gas is provided so that a compaction pressure or compaction force (for example, approximately 500N to 1000N) acting on the fibre placement head 14 along the compaction axis 22 remains substantially constant irrespective of the position of the fibre placement head 14 within its travel.

It will be appreciated that if the fibre placement head were not resiliently moveable along the compaction axis, any inaccuracy in the movement of the roller would result in the roller not contacting the lay-up surface if the roller is too high (i.e. above the lay-up surface), or being driven into the lay-up surface (i.e. colliding) if the roller is held too low (i.e. below the lay-up surface). In the latter case, small tolerances may be accommodated by deformation of a deformable roller.

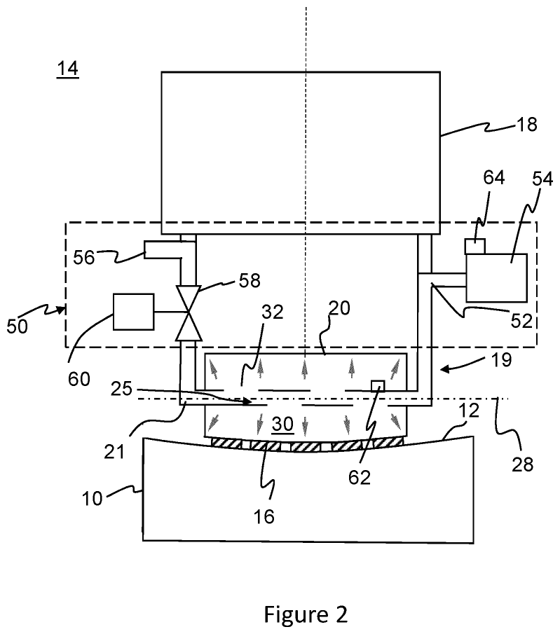

FIG. 2 schematically shows a cross-sectional view of the fibre placement head 14 and the tool 10. The roller 20 is positioned over the tool 10 to press a plurality of tows 16 against the lay-up surface 12 of the tool 10 during a lay-up operation. The roller mount 19 comprises an axle 21 defining a roller axis 28 about which the roller 20 is rotatable to move over the lay-up surface 12 to apply the tows 16 of fibre reinforcement material thereto. In this example, the roller axis 28 is orthogonal with respect to the compaction axis 22, but in other examples the roller axis may be pivotable to become inclined relative the compaction axis.

The roller 20 is hollow and defines an internal chamber 30 which is sealed against the axle 21 with a fluid tight seal at axial ends of the roller 20. The axle 21 is hollow and defines an internal channel 25. The axle 21 comprises a plurality of perforations 32 between the seals at axial ends of the roller 20 (i.e. in a section of the axle 21 over which the roller 20 is mounted). Therefore, the channel 25 of the axle 21 is in fluid communication with the chamber 30 of the roller 20.

The head 14 also comprises a pressurised fluid system 50 which is configured to deliver and discharge pressurised air to and from the internal chamber 30 of the roller 20. In other examples, the pressurised fluid system may be configured to deliver and discharge any fluid to and from the chamber, such as nitrogen.

The pressurised fluid system 50 comprises a pressurised fluid inlet 52 to the roller mount 19 which is configured to be fluidically connected to a pressurised fluid source. The pressurised fluid inlet 52 is fluidically connected to the channel 25 of the axle 21. Therefore, the pressurised fluid system is configured to deliver and discharge pressurised air to and from the chamber 30 through the axle 21.

In this example, the pressurised fluid system 50 comprises a pressurised fluid source 54. The pressurised fluid source 54 in this example is a pump. In some examples, the pressurised fluid source may be the compressed gas apparatus of the biasing mechanism including the reservoir of compressed gas and the pneumatic actuator. In other examples it may be a separate fluid source. Configuring the pressurised fluid inlet 52 to be connectable to a reservoir of compressed gas ensures that the fibre placement head 14 is easily retrofittable to an existing fibre placement machine already having a compressed gas reservoir, or that an existing fibre placement head may be easily modified to make the fibre placement head as described above.

In some examples, the pressurised fluid source may comprise a compressor, pump or any other source of pressurised fluid. In other examples, the pressurised fluid system may not comprise a pressurised fluid source, and may merely be configured to be connected to one.

The pressurised fluid system 50 also comprises a pressurised fluid outlet 56 from the roller mount 19 which is configured to allow discharge of fluid from the chamber 30 to atmosphere. In other examples, the pressurised fluid outlet may be configured to allow discharge of fluid into a closed circuit to be fed back into a pressurised fluid source, and thus back into the chamber.

Pressure is maintained in the chamber 30 by an outlet valve 58 which is disposed at the pressurised fluid outlet 56. The outlet valve 58 prevents the discharge of pressurised air in the chamber 30 to atmosphere when it is closed, and permits discharge of the pressurised air from the chamber 30 when it is open. In this example, the outlet valve 58 is a pressure-maintaining valve which is mechanically configured so that when pressure in the chamber 30 exceeds a pressure release threshold, the outlet valve 58 passively opens to permit discharge of the air (i.e. it opens without the requirement of additional external stimulus).

In this example, the pressure release threshold of the outlet valve 58 is variable so as to enable control of pressure in the chamber 30.

The roller 20 is configured to deform to at least partially conform to the lay-up surface 12. The pressure of fluid in the chamber 30 corresponds to a radial stiffness of the roller 20, which determines the compaction or compliance of a roller to a surface curved about any axis which is non-parallel with the roller axis 28 (such as the lay-up surface 12 shown in FIG. 2), when compressed against the surface. A lower radial stiffness makes the roller more compliant to a curved lay-up surface (i.e. it will deform more for the same compaction force), and a higher radial stiffness makes the roller less compliant to a curved lay-up surface (i.e. it will deform less for the same compaction force).

If the radial stiffness of the roller 20 is too high, the roller 20 may not be able to conform to a lay-up surface 12 with a high curvature. Therefore, non-conformance such as bridging may occur in which some of the tows 16 are not compacted against the lay-up surface in a depression or recess. If the radial stiffness of the roller 20 is too low, there may be inadequate application of pressure against the tows 16 for adhesion of the fibre reinforcement material during a lay-up operation. Further, if the radial stiffness of the roller is too low, steering of the tows 16 may be affected (i.e. the tows 16 may deviate from the intended course during lay-up because the pressure from the roller on the tows 16 is too low to cause the tows 16 to change direction).

Therefore, there is a compromise in radial stiffness between it being low enough to avoid such non-conformance, and it being high enough to ensure that tows are properly compacted and steered. Accordingly, there may be an optimal stiffness which is dependent on the profile and curvature of the lay-up surface and the intended course of the tows (i.e. the intended headpath of the fibre placement head 14).

The pressurised fluid system 50 comprises a controller 60 to control the discharge of fluid from the chamber 30, thereby controlling the pressure in the chamber 30 and the radial stiffness of the roller 20.

In this example, the controller 60 controls the variable pressure release threshold of the outlet valve 58. One way of providing such control is for the outlet valve 58 to be retained in a closed position by a biasing force acting on a poppet in a seat. The biasing force may be from a spring, for example, or pneumatic pressure from a compressed air chamber. If the biasing force is increased or decreased, the pressure release threshold is correspondingly increased or decreased. Therefore, by changing the stiffness of the spring or the pressure of the air in a compressed air chamber of an outlet valve, the pressure release threshold of the valve may be changed, and thus the pressure in the chamber 30 may be changed. In other examples, the pressure release threshold may be changed in any suitable manner.

The controller 60 is configured to receive pressure control data for varying pressure within the chamber along a pre-programmed headpath of the fibre placement head. The controller 60 in this example is pre-programmed with the pressure control data. In other examples, the controller may receive the pressure control data in real-time during a lay-up operation. The pressure control data may be varying in time (i.e. data relating to variable predefined pressures correlated to time in a lay-up operation) or it may vary in space (i.e. data relating to variable predefined pressures correlated to a position of the fibre placement head in space). The controller 60 is configured to control the pressure in the chamber 30 based on the pressure control data by dynamically changing the pressure release threshold of the outlet valve 58, so as to vary the radial stiffness of the roller 20 at all points along the headpath of the fibre placement head 14 during a lay-up operation to correspond to the variable predefined pressures, which may be an optimum pressure determined as set above.

In other examples, the controller may be configured to actively control opening and closing of the outlet valve, to thereby control the pressure in the chamber. This may be done by opening and closing the outlet valve at a given frequency or duty cycle, or maintaining the valve in an open configuration with a variable orifice size.

In this example, the pressurised fluid system 50 also comprises a heater 64 configured to heat the pressurised air entering at the pressurised fluid inlet 52. Therefore, the pressurised fluid system is configured to deliver heated air to the chamber 30 in use. Delivering heated air to the chamber 30 enables heat transfer to the roller 20 and tows 16 during a lay-up operation. Heating tows 16 helps them to adhere to the lay-up surface 12 or a substrate on the lay-up surface 12, particularly if the tows 16 comprise fibre reinforcement material pre-impregnated with resin.

In some examples, the pressurised fluid may already be heated in the pressurised fluid source, such that no separate or additional heater is required to heat the air. In further examples, the air may not be heated, such that there may be no heater.

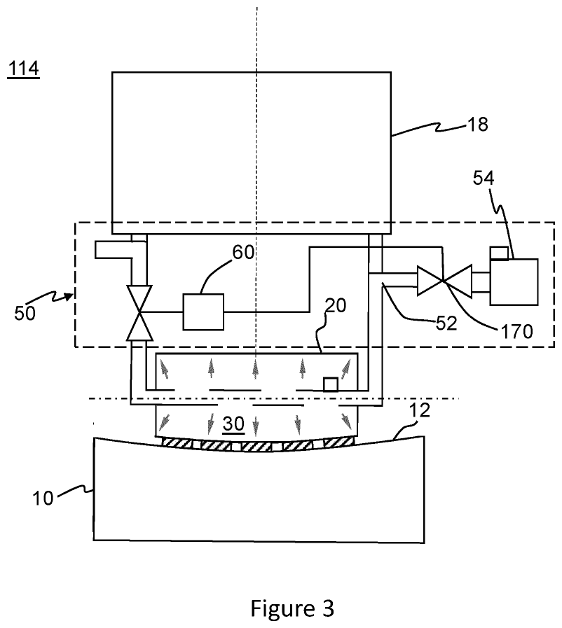

FIG. 3 shows a second example fibre placement head 114 which comprises all of the same features as the first example fibre placement head 14 of FIG. 2, except that the pressurised fluid source 54 in this example is the compressed gas apparatus of the biasing mechanism, including the reservoir of compressed gas and the pneumatic actuator. In variants of this example, the pressurised fluid source may be a pump or any other kind of fluid source. The pressurised fluid system 50 of the fibre placement head 114 further includes an inlet valve 170 disposed at the pressurised fluid inlet 52 of the head 114.

The controller 60 is also configured to control the opening and closing of the inlet valve 170, in order to further selectively permit and prevent the intake of pressurised air into the chamber 30. Closing the inlet valve permits the pressure to reduce in the chamber below the pressure of the pressurised fluid source 54. Opening the inlet valve permits the pressure to rise in the chamber.

The pressurised fluid system 50 comprises a sensor 62 disposed in the chamber 30 to monitor the pressure in the chamber 30. The sensor is configured to output a pressure parameter to the controller 60 relating to the pressure in the chamber, and the controller 60 is configured to operate the outlet valve 58 and/or inlet valve 170 in a feedback loop to regulate the pressure in the chamber 30 based on the pressure parameter and the pressure control data.

In some examples, the sensor may merely output a pressure parameter for display or other monitoring purposes, for example, for calibrating the controller and outlet and inlet valves. The sensor may also be present in the first example fibre placement head 14, or may be omitted in a variant of the second example fibre placement head.

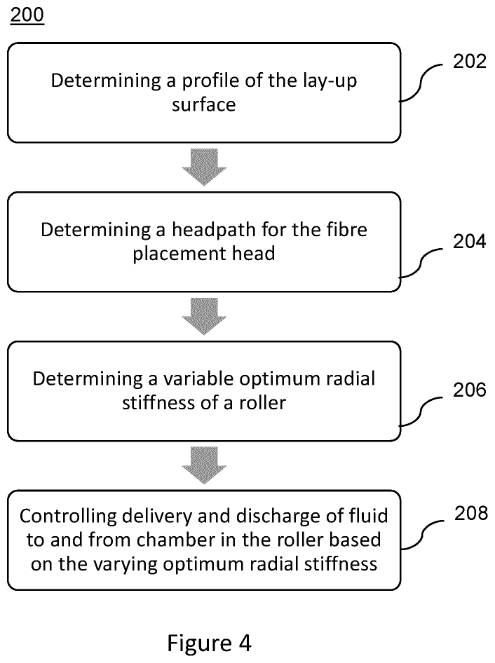

FIG. 4 is a flow chart showing steps of a process 200 for laying-up fibre reinforcement material on a lay-up surface using an example fibre placement head 14, 114 as described above with reference to FIGS. 2 and 3.

In box 202, the process includes determining a profile of the lay-up surface 12. In box 204, the process includes determining a headpath for the fibre placement head 14 (i.e. a predetermined route over the lay-up surface of the roller 20).

In box 206, the profile of the lay-up surface 12 and the headpath of the fibre placement head 14, 114 are used to determine a variable radial stiffness of the roller 20 during a lay-up operation which may be an optimum stiffness determined as set out above.

In box 208, the process includes controlling discharge of fluid from the chamber 30 in the roller 20 based on the variable radial stiffness during a lay-up operation. The process may also include controlling delivery of to the chamber in the roller.

In some examples, the headpath for the fibre placement head may not be predetermined, and the profile of the lay-up surface directly under the roller is monitored in real time during the lay-up procedure. Therefore, a variable stiffness is determined during the lay-up operation based on the real-time monitoring of the profile. The delivery and discharge of fluid is then controlled based on the real-time monitoring of the profile during the lay-up operation.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A fibre placement head comprising:
a roller mount comprising an axle defining a roller axis;
a hollow roller defining an internal chamber, the roller being mounted on the axle and configured to rotate about the roller axis; and
a pressurised fluid system configured to deliver and discharge pressurised fluid to and from the internal chamber of the roller, to vary a stiffness of the roller by varying a pressure of fluid in the chamber;
wherein the pressurised fluid system comprises a controller configured to control the discharge;
wherein the controller is configured to receive pressure control data, relating to time-varying or space-varying optimised pressure within the chamber along a pre-programmed headpath for the fibre placement head, and wherein the controller is configured to control the pressure in the chamber based on the pressure control data such that the stiffness of the roller is varied along the headpath of the fibre placement head.

2. The fibre placement head according to claim 1, wherein the pressurised fluid system is configured to deliver and discharge the pressurised fluid to and from the internal chamber of the roller through the axle of the roller mount.

3. The fibre placement head according to claim 1, wherein the controller is configured to control the delivery of the fluid in the chamber to control the pressure in the chamber.

4. The fibre placement head according to claim 1, wherein the pressurised fluid system comprises a pressurised fluid inlet configured to be fluidically connected to a pressurised fluid source, and a pressurised fluid outlet configured to allow discharge of the pressurised fluid from the internal chamber.

5. The fibre placement head according to claim 4, wherein the pressurised fluid system comprises an outlet valve disposed at the pressurised fluid outlet, and selectively openable to allow discharge of the pressurised fluid from the internal chamber, to thereby control the pressure within the internal chamber.

6. The fibre placement head according to claim 4, wherein the pressurised fluid system comprises an outlet valve disposed at the pressurised fluid outlet, and wherein the outlet valve has a pressure release threshold such that the outlet valve passively opens when pressure of the pressurised fluid in the internal chamber exceeds the pressure release threshold.

7. The fibre placement head according to claim 6, wherein the controller is configured to control the pressure release threshold of the outlet valve.

8. The fibre placement head according to claim 4, wherein the pressurised fluid system comprises an inlet valve disposed at the pressurised fluid inlet.

9. The fibre placement head according to claim 8, wherein the controller is configured to control selective opening and closing of the inlet valve.

10-11. (canceled)

12. The fibre placement head according to claim 4, wherein the pressurised fluid system comprises a pressurised fluid source connected to the pressurised fluid inlet.

13. The fibre placement head according to claim 12, wherein the pressurised fluid source is a pneumatic actuator.

14. The fibre placement head according to claim 1, wherein the pressurised fluid system comprises a sensor disposed within the internal chamber to monitor the pressure of the pressurised fluid within the chamber and to generate a pressure parameter which is representative of the pressure in the internal chamber.

15. The fibre placement head according to claim 14, wherein the controller receives the pressure parameter from the sensor, and controls discharge of the pressurised fluid from the internal chamber based on the pressure parameter.

16. The fibre placement head according to claim 1, wherein the pressurised fluid system comprises a heater such that the pressurised fluid system is configured to deliver heated pressurised fluid to the internal chamber of the roller.

17. A fibre placement machine comprising a fibre placement head comprising:
a roller mount comprising an axle defining a roller axis;
a hollow roller defining an internal chamber, the roller being mounted on the axle and configured to rotate about the roller axis; and
a pressurised fluid system configured to deliver and discharge pressurised fluid to and from the internal chamber of the roller, to vary a stiffness of the roller by varying a pressure of fluid in the chamber;
wherein the pressurised fluid system comprises a controller configured to control the discharge;
wherein the controller is configured to receive pressure control data, relating to time-varying or space-varying optimised pressure within the internal chamber along a pre-programmed headpath for the fibre placement head, and wherein the controller is configured to control the pressure in the internal chamber based on the pressure control data such that the stiffness of the roller is varied along the headpath of the fibre placement head.

18. The method of laying up fibre reinforcement material on a lay-up surface with a fibre placement head according to claim 1, the method comprising:
controlling the discharge of the pressurised fluid from the internal chamber of the roller to vary the pressure in the internal chamber of the roller during lay-up.

19. The method according to claim 18, further comprising controlling the delivery of the pressurised fluid into the chamber of the roller to vary the pressure in the internal chamber of the roller during lay-up.

20. The method according to claim 19, wherein a controller receives pressure control data relating to a predetermined variable stiffness, and wherein the controller controls the delivery or discharge of pressurised fluid from the internal chamber during lay-up based on the pressure control data.

21. (canceled)

22. The method according to claim 20, comprising determining pressure control data for controlling the discharge of the pressurised fluid from the internal chamber of the roller during lay-up, wherein the determination is based on determining a variable stiffness of the roller along the headpath based on a profile of the lay-up surface along the headpath.

23. A fibre placement head comprising:
a roller mount comprising an axle defining a roller axis;
a hollow roller defining an internal chamber, the roller being mounted on the axle and configured to rotate about the roller axis; and
a pressurised fluid system configured to deliver and discharge pressurised fluid to and from the internal chamber of the roller, to vary a stiffness of the roller by varying a pressure of fluid in the chamber;
wherein the pressurised fluid system comprises a pressurised fluid inlet configured to be fluidically connected to a pressurised fluid source, and a pressurised fluid outlet configured to allow discharge of the pressurised fluid from the internal chamber;
wherein the pressurised fluid system comprises an outlet valve disposed at the pressurised fluid outlet, and wherein the outlet valve has a pressure release threshold such that the outlet valve passively opens when pressure of the pressurised fluid in the internal chamber exceeds the pressure release threshold;
wherein the pressurised fluid system comprises a controller configured to control the discharge, wherein the controller is configured to control the pressure release threshold of the outlet valve.
